(19) United States
(12) Patent Application Publication
(10) Pub. No.: US 2025/0094784 A1
(43) Pub. Date: Mar. 20, 2025

(54) LAYER NORMALIZATION FOR CALIBRATED UNCERTAINTY IN DEEP LEARNING

(71) Applicant: INTERNATIONAL BUSINESS MACHINES CORPORATION, Armonk, NY (US)

(72) Inventors: Thomas Frick, Winterthur (CH); Mattia Rigotti, Basel (CH); Diego Matteo Antognini, Ruvigliana (CH); Ioana Giurgiu, Zürich (CH); Adelmo Cristiano Innocenza Malossi, Schönenberg (CH)

(21) Appl. No.: 18/470,714

(22) Filed: Sep. 20, 2023

(51) Int. Cl. G06N 3/047; G06N 3/048

(52) U.S. Cl. CPC G06N 3/047; G06N 3/048

(57) ABSTRACT

Layer normalization in machine learning applications that includes sampling a random set of activations corresponding to a fix fraction of the overall activations to provide a plurality of subsampled activations; computing the average across the plurality of subsampled activations; and computing the standard deviation across the plurality of subsampled activations. The layer normalization further includes employing two statistics including the average of the subsampled activations and the standard deviation across the plurality of subsampled activations to normalize all of the activations as a layer normalization.

### BACKGROUND

The present invention generally relates to artificial intelligence, and more particularly to layer normalization in deep learning applications.

Endowing neural networks with a mechanism for efficiently estimating the uncertainty of their predictions is a problem that is acquiring increasing attention as these models are being deployed in critical decision making settings. In real-world applications such as autonomous driving, robotics, or medical diagnosis models are often operating in an out-of-distribution situation compared to the training data. In such scenarios, calibrated prediction uncertainty is crucial to meaningfully compare competing predictions and decide when to trust them or ignore them if deemed implausible.

Bayesian methods, such as Bayesian Deep Neural Networks (DNNs), offer a principled formalism to compute uncertainty measures. Their disadvantage is that obtaining uncertainty measures over complex models, such as large neural networks quickly becomes intractable, because of the computational challenge of estimating and updating posteriors over their parameters. To overcome these issues, proposed approximate Bayesian methods have been attempted that make use of variational approximations resulting in implementations that conveniently leverage sampling mechanisms that are inherently present in modern DNNs, such as Dropout and Batch Normalization. MC Dropout, for instance cleverly exploits the fact that Dropout noise can be interpreted as a sampling mechanism over a variational distribution approximating the posterior of the DNNs parameters given the training data. Following this work, the stochastic nature of the mini-batch sampling process exposed by Batch Normalization (Batch Norm) layers has also been used to perform approximate Bayesian inference for uncertainty estimation, and domain-adaptive prediction time calibration of uncertainty.

### SUMMARY

In accordance with some embodiments of the present disclosure, computer implemented methods, systems and computer program products have been provided for layer normalization for calibrated uncertainty in deep learning.

Developing a mechanism for efficiently estimating the uncertainty of predictions made by neural networks represents a challenge. Accurate uncertainty estimates are advantageous for real-world applications where out-of-distribution shifts compared to training data may occur. In these scenarios, calibrated prediction uncertainty plays a crucial role in determining when to trust a model's outputs or discard them as implausible.

Described herein is a deep learning module that can be used as a drop-in replacement for Layer Normalization blocks to seamlessly endow a neural network with uncertainty estimation capabilities. The deep learning module described herein, also referred to as a Monte Carlo (MC) Layer Normalization, offers complementary applicability to related modules such as MC Dropout, and MC Batch Normalization. In some embodiments, the deep learning module described herein (MC Layer Normalization) can be used when the latter two modules, e.g., MC Dropout and MC Batch Normalization, are not technically applicable or suboptimal. Despite being simple to deploy with no significant computational overhead at training, MC Layer Normalization is motivated from an approximate Bayesian perspective.

The methods, system and computer program products that are described herein can empirically demonstrate the competitiveness of MC Layer Normalization module compared to state-of-the-art alternatives in terms of prediction accuracy and uncertainty calibration in a variety of settings, including established benchmarks for out-of-distribution image classification. Further, the model has the capability for zero-shot prediction-time domain adaptation, and its applicability in situations where the known alternatives are not applicable as they are incompatible with the architecture.

The MC Layer Normalization can be used in neural networks that provide for artificial intelligence in autonomous driving, objection detection, and decision-making support in applications such as in medical diagnosis support.

In one aspect, a computer implemented method is provided for layer normalization in machine learning applications. In some embodiments, the computer implemented method enables deep neural networks to perform reliable predictions with calibrated uncertainty by using a Monte Carlo Normalization module. MC-layer Normalization is a normalization layer that is used while training a neural network. The MC-Layer Normalization functions to normalize the activations of a layer upstream from it. The activation function is typically applied to the output of each neuron in the network. It takes in the weighted sum of the inputs and produces an output that is then passed on to the next layer.

In one embodiment, the computer implemented method is provided for layer normalization in machine learning applications includes sampling a random set of activations corresponding to fix fraction of the overall activations to provide a plurality of subsampled activations; and computing the average across the plurality of subsampled activations. The computer implemented method may also include computing the standard deviation across the plurality of subsampled activations. The computer implemented methods can than employ two statistics including the average of the subsampled activations and the standard deviation across the plurality of subsampled activations to normalize all of the activations as a layer normalization.

In another embodiment, a computer implemented method is provided for layer normalization in machine learning applications includes a training sequence that includes sampling a random set of activations corresponding to fix fraction of the overall activations to provide a plurality of subsampled activations; and computing the average across the plurality of subsampled activations. The training sequence of the computer implemented method may also include computing the standard deviation across the plurality of subsampled activations. The training sequence of the computer implemented methods can than employ two statistics including the average of the subsampled activations and the standard deviation across the plurality of subsampled activations to normalize all of the activations as a layer normalization. Following the training sequence, the computer implemented method may perform an evaluation sequence employing a Monte Carlo approximation that includes using a subsample input feature for calculation of normalization statics, and computing the average of running the network forward multiple times with the layer normalization from the training sequence, wherein the average is an output providing a prediction.

In another embodiment, a computer implemented method is provided for layer normalization in machine learning applications includes a training sequence that includes sampling a random set of activations corresponding to fix fraction of the overall activations to provide a plurality of subsampled activations; and computing the average across the plurality of subsampled activations. The training sequence of the computer implemented method may also include computing the standard deviation across the plurality of subsampled activations. The training sequence of the computer implemented methods can than employ two statistics including the average of the subsampled activations and the standard deviation across the plurality of subsampled activations to normalize all of the activations as a layer normalization. Following the training sequence, the computer implemented method may perform an evaluation sequence employing a Monte Carlo approximation that includes using a subsample input feature for calculation of normalization statics, and computing the average of running the network forward multiple times with the layer normalization from the training sequence, wherein the average is an output providing a prediction.

In yet another embodiment, a computer implemented method is provided for layer normalization in machine learning applications includes a training sequence that includes sampling a random set of activations corresponding to fix fraction of the overall activations to provide a plurality of subsampled activations; and computing the average across the plurality of subsampled activations. The training sequence of the computer implemented method may also include computing the standard deviation across the plurality of subsampled activations. The training sequence of the computer implemented methods can than employ two statistics including the average of the subsampled activations and the standard deviation across the plurality of subsampled activations to normalize all of the activations as a Monte Carlo layer normalization. Following the training sequence, the computer implemented method may perform an evaluation sequence including a sampling procedure that translates to the Monte Carlo layer normalization of the training sequence, and providing a prediction using a Laplace approximation without subsampling of the input features. In another aspect, a system for layer normalization in machine learning applications is

described that includes a hardware processor; and a memory that stores a computer program product. In one example, the computer program product of the system includes instructions to sample, with the hardware processor, a random set of activations corresponding to fix fraction of the overall activations to provide a plurality of subsampled activations; and to compute, with the hardware processor, the average across the plurality of subsampled activations. The computer program product further includes computing, using the hardware process, the standard deviation across the plurality of subsampled activations. The computer program product of the system can than employ, using the hardware processor, two statistics including the average of the subsampled activations and the standard deviation across the plurality of subsampled activations to normalize all of the activations as a layer normalization.

In yet another aspect, the present disclosure describes a computer program product for layer normalization in machine learning applications. The computer program product can include a computer readable storage medium having computer readable program code embodied therewith.

The program instructions executable by a processor to cause the processor to sample a random set of activations corresponding to fix fraction of the overall activations to provide a plurality of subsampled activations; and to compute, with the hardware processor, the average across the plurality of subsampled activations. The computer program product further includes instructions to compute, using the hardware process, the standard deviation across the plurality of subsampled activations. The computer program product of the system can than employ, using the hardware processor, two statistics including the average of the subsampled activations and the standard deviation across the plurality of subsampled activations to normalize all of the activations as a layer normalization.

### BRIEF DESCRIPTION OF THE DRAWINGS

The following description will provide details of preferred embodiments with reference to the following figures wherein:

FIG. 1 is a flow/block diagram depicting a method for Monte Carlo (MC) layer normalization for calibrated uncertainty in deep learning methods, in accordance with one embodiment of the present disclosure.

FIG. 2 is a flow/block diagram depicting a method for Monte Carlo (MC) layer normalization for calibrated uncertainty in deep learning methods, in accordance with another embodiment of the present disclosure.

FIG. 3 is an illustration of an example environment illustrating a neural network for an artificial intelligence model.

FIG. 4 is a plot illustrating a comparison of LayerNorm, BatchNorm, Prediction-Time BatchNorm as well as MC-LayerNorm on the expected calibration error (ECE), Brier score, and accuracy from CIFAR-10-C.

FIG. 5 is a plot of first data set from TinyImageNet-C for Calibration for in-distribution (Test), out-of-distribution (OOD) and a real world scenario (Mix).

FIG. 6 is a plot of a second data set from CIFAR-10-C for Calibration for in-distribution (Test), out-of-distribution (OOD) and a real world scenario (Mix).

FIG. 7 is a plot of a second data set from TinyImageNet-C for Calibration for in-distribution (Test), out-of-distribution (OOD) and a real world scenario (Mix).

FIG. 8 depicts plots of the results on the Criteo dataset demonstrating an of MC-LayerNorm when it comes to all three of the considered metrics of area under the curve (AUC), expected calibration error (ECE) and Brier score.

FIG. 9 is a block diagram of a system for machine learning that employs a Monte Carlo (MC) layer normalization for calibrated uncertainty in deep learning methods, in accordance with one embodiment of the present disclosure.

FIG. 10 depicts a computing environment according to an embodiment of the present disclosure.

### DETAILED DESCRIPTION

The methods, systems, and computer program products described herein can provide for layer normalization for calibrated uncertainty in deep learning methods. Training Deep Neural Networks is a difficult task that involves several problems to tackle. Despite their huge potential, they can be slow and be prone to overfitting. Batch and layer normalization are two strategies for training neural networks faster, without having to be overly cautious with initialization and other regularization techniques. In layer normalization, all neurons in a particular layer effectively have the same distribution across all features for a given input. Normalizing across all features but for each of the inputs to a specific layer removes the dependence on batches. This makes layer normalization well suited for sequence models such as transformers and recurrent neural networks (RNNs). Some features of layer normalization include that layer normalization normalizes each of the inputs in the batch independently across all features. As batch normalization is dependent on batch size, it's not effective for small batch sizes. Layer normalization is independent of the batch size, so it can be applied to batches with smaller sizes as well. Further, batch normalization requires different processing at training and inference times. As layer normalization is done along the length of input to a specific layer, the same set of operations can be used at both training and inference times.

In some embodiments, the methods, systems, and computer program products described herein can provide a deep learning module that inserts itself neatly in a line of research and development of sampling-based deep learning layers for estimating the uncertainty of the prediction on neural network models. In particular, the layer normalization provided herein, which may be referred to as Monte Carlo (MC) layer normalization, can be used as a drop-in replacement for layer normalization blocks to seamlessly endow a neural network with uncertainty calibration capabilities.

As further described below the layer normalization, named Monte Carlo (MC) Layer Normalization (MC-LayerNorm), includes of a stochastic variant of Layer Normalization

(LayerNorm) that it is replacing and offers complementary applicability to related modules such as MC Dropout and MC BatchNorm.

Monte Carlo Dropout (MC-Dropout) approximates Bayesian inference in neural networks for uncertainty estimates using dropout. Dropout sets a portion of the input features to zero at training time, while not dropping any input features at test time. MC-Dropout introduces stochasticity at inference time by using the training behavior at test time. The inference time is how long it takes for a forward propagation. To get the number of Frames per Second, we divide 1/inference time. In deep learning, inference time is the amount of time it takes for a machine learning model to process new data and make a prediction. Turning to the test time, the purpose of testing is to compare the outputs from the neural network against targets in an independent set (the testing instances).

If all the testing metrics are considered ok, the neural network can move to the so-called deployment phase, also referred to as prediction.

Monte Carlo Batch Normalization (MC BatchNorm) introduces an alternative based on the properties of the batch normalization statistics leveraging training-time batch statistics at test time. Batch normalization is a technique for training very deep neural networks that standardizes the inputs to a layer for each mini-batch. In the formula for batch normalization, given a batch of activations for a specific layer, it first calculates the mean and standard deviation for the batch. Then, it subtracts the mean and divides by the standard deviation to normalize the values. An epsilon is added to the standard deviation for numerical stability.

When performing a Monte Carlo Batch Normalization (MC BatchNorm), instead of utilizing the running batch statistics at inference time, Monte Carlo Batch Normalization (MC BatchNorm) method approximates bayesian inference by running multiple forward passes with distinct sets of training-time normalization statistics. Prediction-Time Batch Normalization as a countermeasure to the covariate shift that comes with out-of-distribution data samples. The method works by discarding the running batch statistics of batch normalization layers and instead using the batch statistics of each separate batch at test time. This effectively counteracts the covariate shift and significantly improves model calibration.

The layer normalization employed in the methods, systems and computer program products, named Monte Carlo (MC) Layer Normalization (MC-LayerNorm), can be used in training settings and architectures where the latter two modules, i.e., Monte Carlo Dropout (MC-Dropout) and Monte Carlo Batch Normalization (MC BatchNorm), are not technically applicable, or result in sub-optimal performance. In addition, MC-LayerNorm inherits the advantages of Layer Norm over BatchNorm, including the fact that its training behavior does not depend on the mini-batch size and that is invariant to single input data re-scaling. It has been determined that this last property is particularly appealing as it endows the layer normalization of the present disclosure, i.e., MC-LayerNorm, with the capability of performing zero-shot domain adaptation at prediction time.

MC-LayerNorm can be motivated from an approximate Bayesian perspective while being easy to deploy in practice with no significant computational overheads at training. The layer normalization provided herein, i.e., MCLayerNorm, is superior to state-of-the-art alternatives, such as Monte Carlo Dropout (MC-Dropout) and Monte Carlo Batch Normalization (MC BatchNorm), in terms of prediction accuracy and uncertainty calibration in a variety of experimental settings, including established benchmarks for out-of-distribution (OOD) image classification.

The layer normalization provided herein, i.e., MCLayerNorm, is suitable for CTR prediction on a Criteo dataset, in which the known competing methods, such as Monte Carlo Dropout (MC-Dropout) and Monte Carlo Batch Normalization (MC BatchNorm), cannot be used as they are incompatible with the associated architecture. For example, in the case of CTR prediction on the Criteo dataset, the current state-of-the-art model does not include Dropout or Batch Norm layers, which precludes the use of MC Dropout or MC BatchNorm.

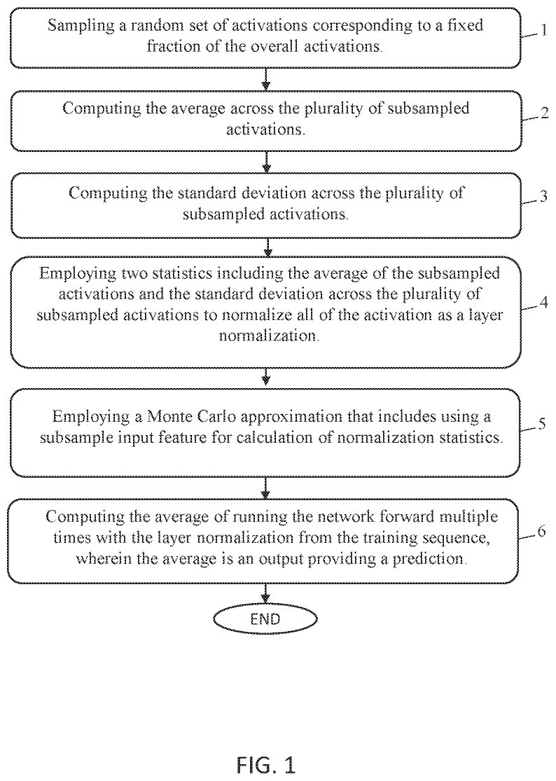

The methods, systems and computer program products of the present disclosure are now described in greater detail with reference to FIGS. 1-10.

FIG. 1 is a flow/block diagram depicting a Monte Carlo (MC) layer normalization for calibrated uncertainty in Deep Learning methods, in accordance with one embodiment of the present disclosure.

The normalization module described herein and referred to as an MC layer normalization, is in some aspects similar to Monte Carlo Batch Normalization, in that the MC layer normalization allows for uncertainty estimation. In some examples, the MC layer normalization allows for an uncertainty estimation in particular through Monte Carlo sampling over a source of randomness. In some embodiments, instead of sampling randomness originating from the stochasticity of mini-batches such as in Monte Carlo Batch Normalization (MC BatchNorm), the MC layer normalization is a variant of Layer Normalization, in which stochasticity is injected by subsampling features when computing the normalization the statistics used to normalize the feature vector. Referring to b lock 1 of FIG. 1, the learning stage of the MC Layer Normalization neural network, can include sampling a random set S of activations corresponding to a fixed fraction of overall activations, e.g., pre-activation.

In some embodiments, MC layer normalization may begin with a Normalization Layer, in which consideration is first made to the l-th hidden layer in a feed-forward neural network, and let a^{l} be the vector representation of the summed inputs to the neurons (preactivations) in the layer.

Activation functions play a crucial role in neural networks, performing a vital function in hidden layers to solve complex problems and to analyze and transmit data throughout deep learning algorithms. There are dozens of activation functions, including binary, linear, and numerous non-linear variants. The activation function defines the output of a node based on a set of specific inputs in machine learning, deep neural networks, and artificial neural networks. Activation functions in artificial neural networks are comparable to cells and neurons in the human brain. The pre-activation value, is the value computed before applying the activation function, whereas the post-activation value is the value computed after applying the activation, output of a neuron.

The preactivations are computed through matrix-vector multiplication of the weight matrix W¹=(wᵢⱼⁱ) and the inputs to the layer h^{l} as:

$${a}_{i}^{l} = {\sum }_{j} {w}_{ij}^{l} {h}_{j}^{l} , \qquad Equation ( 1 )$$

$${h}_{i}^{1 + l} = f ( {a}_{i}^{l} + {b}_{i}^{l} ) ,$$

where ƒ(⋅) is an element-wise activation function such as ReLU and bᵢ^{l} is a bias parameter.

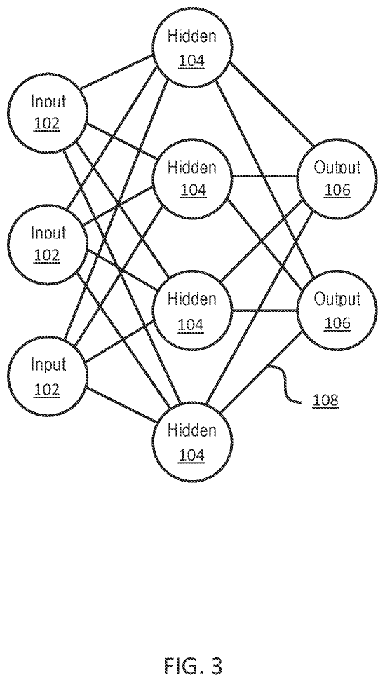

It is noted that neural networks and feed forward computations are further explained with reference to FIG. 3. An artificial neural network (ANN) is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

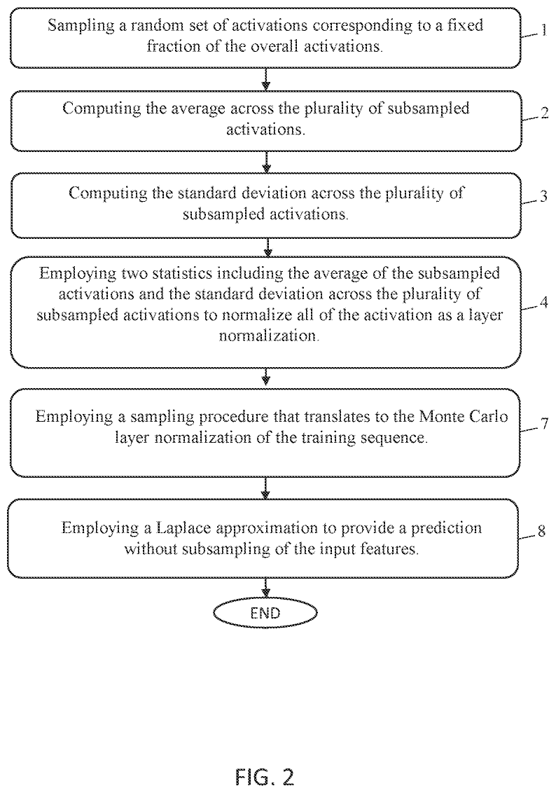

Referring now to FIG. 2, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 102 that provide information to one or more “hidden” neurons 104. Connections 108 between the input neurons 102 and hidden neurons 104 are weighted, and these weighted inputs are then processed by the hidden neurons 104 according to some function in the hidden neurons 104. There can be any number of layers of hidden neurons 104, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 106 accepts and processes weighted input from the last set of hidden neurons 104.

This represents a “feed-forward” computation, where information propagates from input neurons 102 to the output neurons 106. Upon completion of a feed-forward computation, the output is compared to a desired output available from training data. The error relative to the training data is then processed in “backpropagation” computation, where the hidden neurons 104 and input neurons 102 receive information regarding the error propagating backward from the output neurons 106. Once the backward error propagation has been completed, weight updates are performed, with the weighted connections 108 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 108 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 108 may be implemented as resistive processing units (RPUs), generating a predictable current output when an input voltage is applied in accordance with a settable resistance.

Referring back to Layer Normalization, it is noted that Layer Normalization was proposed as a method to mitigate the covariate shift of correlated inputs as an alternative to Batch Normalization, and it consists in normalizing the hidden units in a given layer as āi^{l}=(aᵢ^{l}−μ^{l})/σ^{l} (Layer Normalization) using the μ^{l} and the variance σ^{l} of their preactivations computed as follows:

$${μ}^{l} = \frac{1}{{N}_{l}} {\sum }_{i = 1}^{{N}_{l}} {α}_{i}^{l} , \qquad Equation ( 2 )$$

$${( {σ}^{l} )}^{2} = \frac{1}{{N}_{1}} {\sum }_{i = 1}^{{N}_{l}} {( {α}_{i}^{l} - {μ}^{l} )}^{2} ,$$

where Nₗ is the number of units in layer l.

Referring back to FIG. 1, block 2 of the method may include computing the average across the plurality of subsampled activations. Referring to Equation (2), μ^{l} is the average across the plurality of subsampled activations, in accordance with one embodiment of the present disclosure.

Block 3 of the computer implemented method illustrated in FIG. 1 may continue with computing the standard deviation of across the plurality of subsampled activations. Referring to Equation (2), σ^{l} is the average across the plurality of subsampled activations, in accordance with one embodiment of the present disclosure.

In some embodiments, one advantage of Layer Normalization over Batch Normalization is that it does not rely on any assumption about the size of the mini-batch and can therefore be used in the batch size of 1.

In some embodiments, the MC Layer Normalization (MC-LayerNorm) layer includes modifying Equation (2) by running the averages only over a random subset of units. In some embodiments, a definition is set for [symbol] ⊂[Nₗ]={1, . . . , N₁} obtained by sampling a fixed fraction ƒ of preactivations (or, equivalently, by dropping them with a drop rate of 1-ƒ), and compute the normalized statistics over the sampled units as follows:

$$= \frac{1}{\vert {𝒮}_{l} \vert} {\sum }_{i {ϵ𝒮}_{l}} {a}_{i}^{l} , \qquad Equation ( 3 )$$

$${( )}^{2} = \frac{1}{\vert {𝒮}_{l} \vert} {\sum }_{i {ϵ𝒮}_{l}} {( {a}_{i}^{l} - )}^{2} ,$$

where | [symbol] | denotes the size of the set [symbol] .

Referring to FIG. 1, the computer implemented method may continue to block 4. Block 4 of the computer implemented method depicted in FIG. 1 can include employing two statistics, e.g., the

average (μ^{l}) (mean), and the standard deviation σ^{l}, across the plurality of subsampled preactivations [symbol] to normalize all of the activations as a layer normalization.

As a result, the normalization pre-activations computed by MC-LayerNorm and the resulting outputs of the layer l are:

$${\tilde{a}}_{i}^{l} = ( {a}_{i}^{l} - {\tilde{μ}}^{l} ) / {\tilde{σ}}^{l} , \qquad Equation ( 4 )$$

$${\tilde{h}}_{i}^{l + 1} = f ( {\tilde{a}}_{i}^{l} + {b}_{i}^{l} ) .$$

In some embodiments, \tilde{μ}^{l} and \tilde{σ}^{l} are random variables whose realization is determined by the subset of randomly sampled indices [symbol] , and so are ãᵢ^{l}, and the outputs \tilde{h}ᵢ^{l+1}. This observation motivates a probabilistic view of architectures endowed with the MC-LayerNorm.

This represents one embodiment of training set.

The probabilistic view of MC-LayerNorm can assume without loss of generality a supervised learning setting on a training dataset D={(xᵢ, yᵢ)}ᵢ₌₁^{N}, the goal of supervised learning can be formulated as training parameters θ (which include the weights W′ and biases b′ of each layer l) to maximize the likelihood of the dataset D under the predictive probability:

$${p}_{θ} ( y \vert x ) = softmax ( {f}_{θ} ( x ) ) , \qquad Equation ( 5 )$$

where ƒ_{θ}(⋅) is parameterized as a neural network. The variable ƒ_{θ} is network of with MC-LayerNorm during subsampling of the neural network. the The variable x is sample features, and sample features, and y is sample labels. A network ƒ_{θ}(x) endowed with MC-LayerNorm layers can be modeled as a distribution of networks ƒ_{θ}(x)|{\tilde{μ}^{l}, \tilde{σ}^{l}}ₗ), where {\tilde{μ}^{l}, \tilde{σ}^{l}}ₗ is the set of realizations of the random statistics in equation (3) in all layers l. In some embodiments, an equivalent way of seeing this is to think of a sampled network ƒ_{θ}(x)|{\tilde{μ}^{l}, \tilde{σ}^{l}}ₗ) for a given set {\tilde{μ}^{l}, \tilde{σ}^{l}}ₗ as a corresponding network ƒ_{θ}(x), where now \hat{θ} is sampled from a distribution \hat{θ}˜ q_{θ}(\hat{θ}) defined approximately.

In some embodiments, a distribution qθ(\hat{θ}) converges in a specific sense towards a Gaussian distribution around parameters (θ). The variable θ is the parameters of the neural network.

In some embodiments, the method may approximate normality of MC-LayerNorm networks. For example, for Theorem 1, given a network ƒ_{θ}(x) with MC-LayerNorm layers, \hat{ƒ}_{θ}(x) a corresponding network with all C-LayerNorm (Equation (3)) replaced by regular LayerNorm (Equation (2)). Replacing LayerNorm in ƒ̅_{θ}(x) with MC-LayerNorm induces a distribution of models ƒ_{\hat{θ}}(x) with \hat{θ}˜q_{θ}(\hat{θ}). In addition, q_{θ}(\hat{θ}) is asymptotically normal around the parameters θ of ƒ̅_{θ}(x). The variable ƒ̅_{θ} is the network with LayerNorm during subsampling. The variable \hat{ƒ}_{θ} is the parametevisal neural network with parameters (\hat{θ}) sampled for a distribution q_{θ}.

Proof for the above theorem for the MC Layer Normalization is as follows (and may be referred to as Lemma A.1):

$$Denote {V}_{μ} = \frac{1}{{N}_{1} - 1} {\sum }_{i = 1}^{{N}_{1}} {( {a}_{i}^{l} - {μ}^{l} )}^{2} ,$$

$$and$$

$${V}_{{σ}^{2}} = \frac{1}{{N}_{l} - 1} {\sum }_{i = 1}^{{N}_{l}} {( {( {a}_{i}^{1} )}^{2} - {( {μ}^{l} )}^{2} - {σ}_{l}^{2} )}^{2} .$$

Assume Nₗ−| [symbol] |→∞ as | [symbol] |→∞.
Assume that

$$\frac{1}{{N}_{l}} {\sum }_{i = 1}^{{N}_{l}} {( {a}_{i}^{l} )}^{2}$$

is bounded,
to provide that | [symbol] |→∞, | [symbol] |^{1/2}(\hat{μ}^{l}−μ^{l})→d [symbol] (0, V_{μ}).

Assume that

$$\frac{1}{{N}_{l}} {\sum }_{i = 1}^{{N}_{l}} {( {a}_{i}^{l} )}^{4}$$

is bounded,
to provide that | [symbol] |→∞, | [symbol] |^{1/2}(\hat{σ}^{l}−μσ^{l})→d [symbol] (0, V_{σ2}).

The proof is under standard regulatory standard regularity conditions.

In another proposition of the proof for the above theorem for the MC Layer Normalization is as follows (and may be referred to as Proposition A.2):

Under the assumption that ƒ(⋅) in Equation (1) and Equation (4) is differentiable substantially everywhere, Lemma A.1 implies that there exists a variance V such that

$${\vert {𝒮}_{l} \vert}^{1 / 2} ( {\tilde{h}}_{i}^{l + 1} - {h}_{i}^{l + 1} ) \to d 𝒩 ( 0 , V ) .$$

The proof follows a delta method.

The proof in Proposition A.2 means that the effect of the MC layer Normalization is approximately add Gaussian noise to the activations of a corresponding model with Layer Normalization.

The method further includes approximate Baylesian Inference with MC-LayerNorm.

Theorem 1 noted above allows for leveraging methods that use stochastic regulation techniques to perform practical approximate inference in the space of neural networks ƒθ(⋅) by virtue of the fact that they introduce a random variable that allows for sampling over networks. More specifically, this can begin with computing the predictive distribution (p((y|x), D) over outputs y given a new input x and the training dataset D using Bayesian Model Averaging, but by replacing the intractable posterior p(θ|D) over parameters with a tractable variational approximation q*(θ), then marginalizing over θ using Monte Carlo integration:

$$p ( ( y \vert x ) , D ) = \int {p}_{θ} ( y \vert x ) p ( θ \vert D ) d θ \approx \int {p}_{θ} ( y \vert x ) {q}^{*} d θ \approx \frac{1}{N} {\sum }_{n = 1}^{N} {p}_{{\hat{θ}}_{n}} ( y \vert x ) with {\hat{θ}}_{n} ∼ {q}^{*} ( \hat{θ} ) \qquad Equation ( 6 )$$

Referring to FIG. 1, in some embodiments, following training and during evaluation, the computer implemented method may continue to block 5 with employing a sampling process that translates to Money Carlo layer normalization for the training sequence, as described above with reference to Equation (6).

In practice, in a mini-batch Stochastic Grading Descent (SGD) training setting, for each training point and each MC-LayerNorm layer, a subset z,67 is sampled to while computing the Stochastic Grading Descent (SGD) step. This can implement the process of optimizing qθ(\hat{θ}) towards q*(\hat{θ}). At prediction time, Equation (6) indicates to implement Monte Carlo integration by running the network forward N times given an input data x, each time with different realizations of the subset [symbol] . The obtained outputs are then averaged to obtain the final prediction for input x.

Referring to FIG. 1, block 6 may include computing the average of running the network forward multiple times with the layer normalization from the training sequence, wherein the average is an output providing a prediction. These predictions may be used in machine learning applications to autonomous vehicles, object identification and decision-making support. The process flow described with reference to FIG. 1 employs a Monte Carlo approximation mode during prediction time. In the Monte Carlo approximation mode, the subsample input features provide for calculation of normalization statistics. In the Monte Carol approximation mode, a Bayesian perspective is employed. For the Bayesian perspective, N Monte Carlo iterations are run, and the average is employed for predictions.

There is however an additional approximation of the inference process for a network with MC-LayerNorm that allows to compute predictions even more efficiently by exploiting the second part of Theorem 1.

FIG. 2 is a flow/block diagram depicting a method for Monte Carlo (MC) layer normalization for calibrated uncertainty in deep learning methods, in accordance with another embodiment of the present disclosure. FIG. 2 depicts a one show approximation mode for prediction time using the trained neural network. In one embodiment of the one-shot approximation mode, the sampling procedure translates to MC-integration and connects to Bayesian model averaging. Further, with a Laplace approximation, as illustrated in the following Equation (7), a one-shot approximation mode may be realized, in which there is no subsampling of the input features. The process flow that is depicted in FIG. 2 is similar to the process flow that is depicted in FIG. 1. For example, blocks 1, 2, 3 and 4 as described with reference to FIG. 1 is similar to blocks 1, 2, 3 and 4, as described with reference to FIG. 2. The description of blocks 1, 2, 3 and 4 provided above for the process flow depicted in FIG. 1 is suitable for providing one embodiment for the description of blocks 1, 2, 3 and 4 in FIG. 2.

In some embodiments, according to the theorem the distribution \hat{ }θ˜qθ(\hat{ }θ) is approximately normal around the parameters θ of a corresponding network with Layer Normalization, we can approximate the Monte Carlo integration in Equation (6) with:

$$\frac{1}{N} {\sum }_{n = 1}^{N} {p}_{{\hat{θ}}_{n}} ( y \vert x ) with {\hat{θ}}_{n} ∼ {q}^{*} ( \hat{θ} ) = \frac{1}{N} {\sum }_{n = 1}^{N} softmax ( {f}_{{\hat{θ}}_{n}} ( x ) ) \approx softmax ( \overline{{f}_{θ}} ( x ) ) , \qquad Equation ( 7 )$$

where Equation (5) and Laplace's approximation is used based on the asymptotic normality of q_{θ}(\hat{θ}) around 0 for the model \hat{ƒ}_{θ}(x) with regular LayerNorm instead of MC-LayerNorm.

Referring to FIG. 2, block 7 includes employing sampling procedure that translates to Monte Carlo layer normalization of the training sequence. Block 8 includes employing the Laplace approximation to provide a prediction without subsampling of the input features.

This illustrates that at prediction time the method can simply run the model by replacing MC-LayerNorm with regular LayerNorm as a cheap further approximation of the MC integration in Equation (6). We will refer to this modality of use of MC-LayerNorm at prediction time as LayerNorm approximation.

These predictions provided using the process flow depicted in FIG. 2 may be used in machine learning applications to autonomous vehicles, object identification and decision-making support.

The previous results are summarized in pseudocode snippets detailing the use of MC-LayerNorm in practice for training neural networks with SGD with backpropagation Algorithm 1 as follows:

Algorithm 1: MC-LayerNorm module (training mode)

Input: input vector a = (a₁, ... , aᵢ, ... , a_{N})
Input: (parameter) fraction of sampled units f
Sample: [symbol] ⊂ [1, N] selecting [f · N] indices at random
$Compute : \tilde{μ} = \frac{1}{\vert 𝒮 \vert} {\sum }_{i ϵ𝒮} {a}_{i}$
$Compute : {\tilde{σ}}^{2} = \frac{1}{\vert 𝒮 \vert} {\sum }_{i ϵ𝒮} {( {a}_{i} - \hat{μ} )}^{2}$
$Output : \tilde{a} = ( {\tilde{a}}_{1} , … {\tilde{a}}_{i} , … , {\tilde{a}}_{N} ) with {\tilde{a}}_{i} = \frac{{a}_{i} - \tilde{μ}}{\tilde{σ}}$

The previous results are summarized in pseudocode snippets detailing the use of MC-LayerNorm at prediction time with Algorithm 2, as follows:

Algorithm 2: MC-LayerNorm module (Evaluation mode)

Input: input vector a = (a₁, ... , aᵢ, ... , a_{N})
Input: Number of MC samples N_{c}
If mc_integration then //performing MC integration: for n = 1 to N_{c} do
ãⁿ = MC_layerNorm(a) {//Run Algorithm 1}
End for
$Output : \overline{a} = \frac{1}{{N}_{c}} {\sum }_{n = 1}^{{N}_{c}} {\tilde{a}}^{n}$
Else
//LayerNorm approximation:
$Compute : μ = \frac{1}{N} {\sum }_{n = 1}^{N} {a}_{i}$
$Compute : {σ}^{2} = \frac{1}{N} {\sum }_{n = 1}^{N} {( {a}_{i} - μ )}^{2}$
$Output : \overline{a} = ( {\overline{a}}_{1} , … {\overline{a}}_{i} , … , {\overline{a}}_{N} ) with {\overline{a}}_{i} = \frac{{a}_{i} - μ}{σ}$
End if

In the case of convolutional inputs MC-LayerNorm normalizes its inputs over both channel and spatial dimensions.

### Experimental Results

MC-LayerNorm was evaluated for assessing the quality of the predictions (using standard metrics including accuracy). MC-LayerNorm was also evaluated to assess calibration of the prediction distributions. The goal of the experimentation was to determine that the MC-LayerNorm layer does indeed facilitate the models appropriately express uncertainty. In particular, experimentation focused on the out-of-distribution (OOD) setting when training and test distributions differ due to covariate shift, i.e., when the marginal distributions of features are different Pₜᵣₐᵢₙ(x)≠Pₜₑₛₜ(x), but conditional label distributions are preserved Pₜᵣₐᵢₙ (y|x)=Pₜₑₛₜ(y|x). The expectation was then that properly calibrated uncertainty will be reflected in predictions that tend to be less confident on the OOD inputs that are not well represented in the training distribution. The calibration of the uncertainty of predictions was quantified using two measures: expected calibration error (ECE) and Brier score.

### Expected Calibration Error (ECE)

ECE quantifies the difference between the confidence of a model and its accuracy computed on bins of samples sorted by confidence. In ECE, the lower the value the better. Concretely, N predictions were grouped into bins Bᵢ according to confidence, compute the average prediction acc(Bᵢ) within bins, then compute

$$ECE = {\sum }_{i} \frac{{B}_{i}}{N} \vert acc ( {B}_{i} ) - conf ( {B}_{i} ) \vert .$$

As an artifact due to confidence binning, ECE can over-emphasize the tails of the probabilities.

### Brier Score

Brier score is the squared distance between the vector of predicted probabilities and the one-hot encoded true labels. The Brier score decreases monotonically to zero as the predicted probabilities approach the true targets distribution. We conduct experiments for two types of application settings: Setting 1: MC-LayerNorm acts as a viable alternative to the existing methods, such as for real-world scenarios with the sparse occurrence of out-of-distribution samples (e.g., image classification). Setting 2: MCLayerNorm acts as an option for accurate uncertainty estimates in applications where competing methods cannot be used as they are incompatible with the architectures (e.g., models that do not incorporate BatchNorm and/or Dropout for architectural reasons or training infrastructure constraints).

### Image Classification

MC Layer Normalization is empirically compared with Prediction-Time Batch Normalization. Model calibration metrics (accuracy, ECE, and Brier score) were evaluated on CIFAR-10-C, and TinyImageNet. Both datasets are corrupted versions of their original test sets generated by applying one of 15 corruptions, e.g., frost, motion blur, rain. The evaluation was focused on the ConvNext architecture, which has been shown to reach object classification performance with both BatchNorm and LayerNorm normalization. For CIFAR-10-C, the analysis was limited to the pre-trained architecture size “pico”, while for TinyImageNet-C, pre-trained “tiny” variant was employed. No data augmentations were applied during training other than a horizontal flip of the images.

Three randomly initialized models were trained for each hyperparameter configuration, as follows:

### Hyperparameter Tuning Ranges

All models were trained with the AdamW optimizer provided by the timm library (Wightman et al., 2023) using default parameters for β1, β2 and ϵ. Grid-search was employed to tune the learning rate from values between [e−3, 0.5e−4] and for weight decay form values between [0.1, 1e−4]. For CIFAR-10 and TinyImageNet, fine-tuning was run for 50 epochs with a batch size of 512 with a learning rate schedule that started at lrₛtart=0 and linearly increase the learning rate for 1 warm-up epoch. The learning rate was then reduced by 0.1 at epochs [20, 35, 45]. For Criteo, training was run for 100 epochs with a batch size of 1000 reducing the learning rate by 0.1 on a plateau with patience 2 checked on the validation set. All models were trained on an internal cluster consisting of NVIDIA A100 GPUS.

Following training of the initialized models, a single model was selected per normalization method according the measured accuracy on the validation set. Finally, model calibration was for three different scenarios:
1. In-distribution (Test): The original test set of the corresponding dataset is used as a baseline for all metrics.
2. Out-of-distribution (OOD): The metrics are evaluated on the corrupted C-variant test sets (severity 5). This favors Prediction-Time BatchNorm as the batches exclusively consist of out-of-distribution samples. A batch size of 128 was employed.
3. Real-world use case (Mix): This scenario simulates a zero-shot prediction-time domain adaptation setting where a deployed model first encounters OOD samples and hasn't gathered enough observations to re-adapt (as Prediction-Time BatchNorm needs to do on multiple OOD samples). Such a scenario is simulated by creating batches of size N consisting of N−1 in distribution samples and a single out-of-distribution sample. The batch size was as in the OOD setting, and was equal to N=128.

The calibration metrics are then measured only on the out-of-distribution samples.

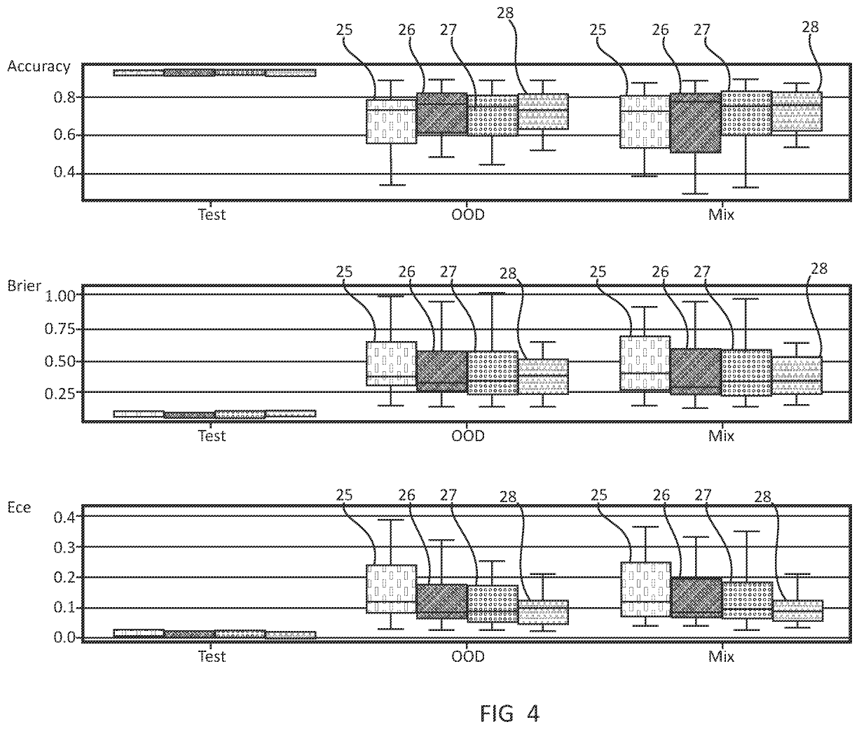

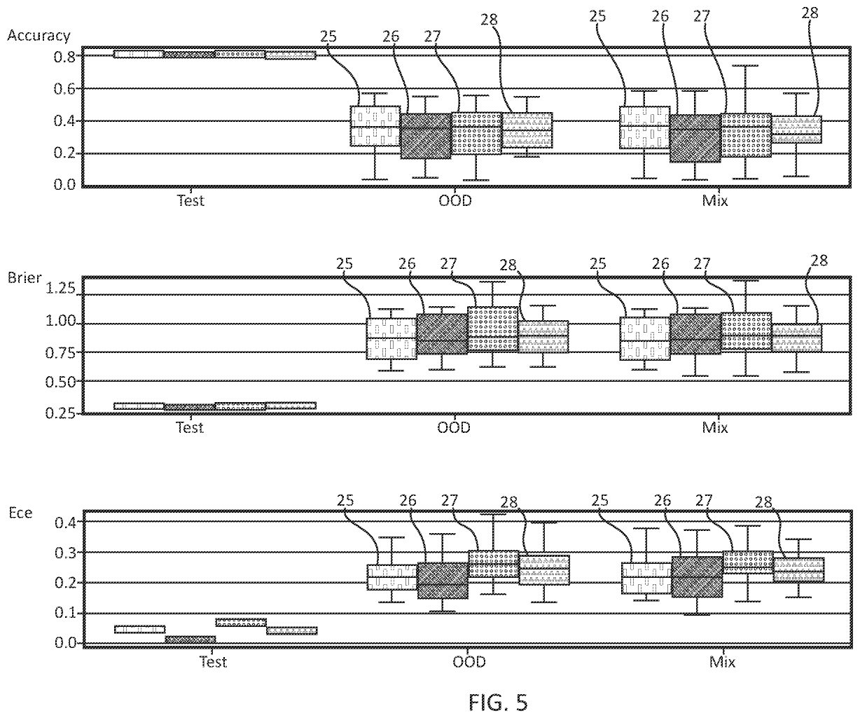

FIG. 4 and FIG. 5 show results for CIFAR-10-C and TinyImageNet-C. The plot identified by reference number 25 is a data set from a BatchNorm layer normalization. The plot identified by reference number 26 is a data set from a LayerNorm layer normalization. The plot identified by reference number 27 is a prediction-BatchNorm layer normalization. The plot identified by reference number 28 is a Monte Carlo Layer Normalization.

FIG. 4 is a plot of data from CIFAR-10-C for in distribution (test), out of distribution (ODD) and a real world scenario (Mix). FIG. 4 illustrates a comparison of LayerNorm, BatchNorme, Prediction-Time BatchNorm as well as MC-LayerNorm on the expected calibration error (ECE), Brier score, and accuracy. While Prediction-Time BatchNorm is superior in the full out-of-distribution (OOD) setting, MC-LayerNorm (f=0.8) outperforms all other methods in the real-world use case (Mix). Error bars are constructed from evaluation runs the 15 corruptions applied to the original test set.

FIG. 5 is a plot of data from TinyImageNet-C for Calibration for in-distribution (Test), out-of-distribution (OOD) and a real world scenario (Mix). FIG. 5 illustrates a comparison of LayerNorm, BatchNorme, Prediction-Time BatchNorm as well as our novel method, MC-LayerNorm (f=0.9) on the expected calibration error (ECE), Brier score, and accuracy. As is the case for the CIFAR-10-C experiments, while not surpassing Prediction-Time Batch Norm in the out-of-distribution setting, LayerNorm is the superior method for the real-world use-case (Mix). Error bars are constructed from evaluation runs the 15 corruptions applied to the original test set.

While MC-LayerNorm accomplishes as well in terms of calibration compared to Prediction-Time BatchNorm in the OOD setting, it outperforms all other normalization methods in the real-world use case (Mix).

Prediction-Time BatchNorm relinquishes much of its performance in the real-world (Mix) use case, as it relies heavily on batches consisting solely of out-of-distribution samples. In contrast, LayerNorm methods do not rely on batch statistics as they calculate normalization statistics across channels and spatial dimensions. Consequently, the MC-LayerNorm method' calibration abilities are independent of batch size, working for small but also for mixed in- and out-of-distribution batches.

The experiments on TinyImageNet-C plotted in FIG. 2 shows a clear superiority of MC-LayerNorm regarding in terms of ECE. Vanilla LayerNorm performs on par with MC-LayerNorm on Brier score while outperforming the vanilla version on ECE. As ECE is independent of model accuracy, MCLayerNorm exhibits a clear benefit for model calibration.

While the experiments aim is to evaluate model calibration under distribution shift, these results also show that MCLayerNorm slightly improves calibration for in-distribution samples.

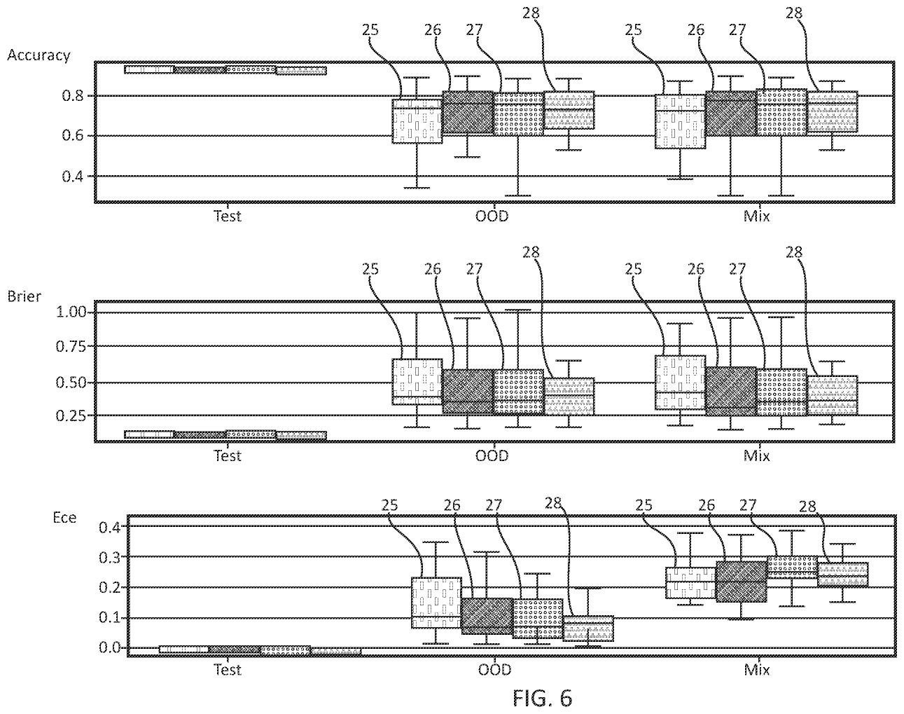

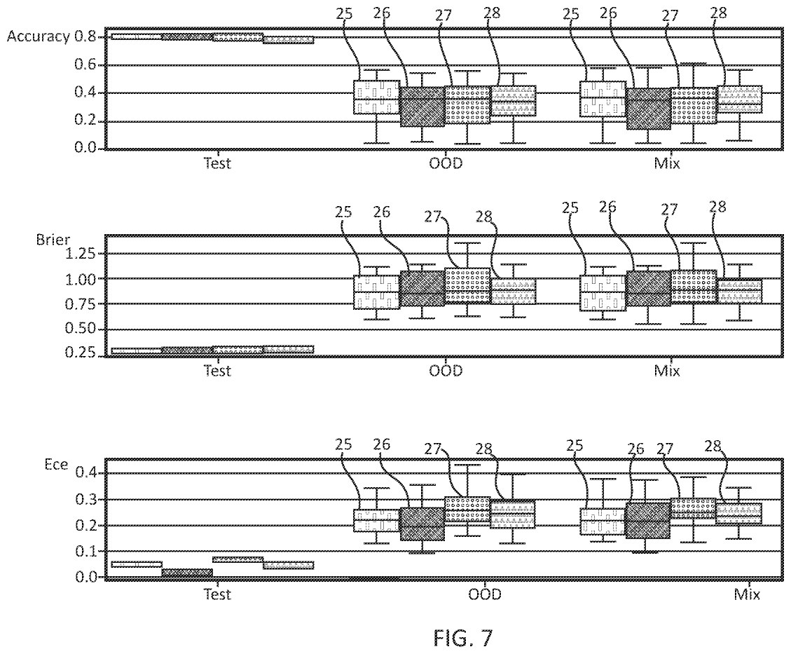

FIGS. 6 and 7 illustrate calibration performance comparisons for varying fractions of sampled features of the MCLayerNorm. The plot identified by reference number 25 is a data set from a BatchNorm layer normalization. The plot identified by reference number 26 is a data set from a LayerNorm layer normalization. The plot identified by reference number 27 is a prediction-BatchNorm layer normalization. The plot identified by reference number 28 is a Monte Carlo Layer Normalization.

FIG. 6 is a plot of data from CIFAR-10-C for Calibration for in-distribution (Test), out-of-distribution (OOD) and a real world scenario (Mix).

FIG. 7 is a plot of data from TinyImageNet-C for Calibration for in-distribution (Test), out-of-distribution (OOD) and a real world scenario (Mix).

The results show that MC-LayerNorm is stable with respect to its only hyper-parameter, the fraction of subsampled features. The model performance and calibration remain stable even for configurations where the normalization is calculated from only 60% of the input features.

### Criteo Display Advertising Challenge

Here, the experimentation showcase the value of MC-LayerNorm in situations where the competing methods cannot be used as they are incompatible with the architectures. For the experiments, models were trained on the Criteo Display Advertising Challenge (CriteoLabs, 2014). The experimentation leveraged the current state-of-the-art model, MaskNet (Wang et al., 2021), relying on the implementation from (Zhu, 2023, Apache-2.0 license). Two types of models were trained: the original MaskNet model containing vanilla LayerNorm and a patched model for which all LayerNorm layers were replaced with MC-LayerNorm.

At prediction time, the MC-LayerNorm models were run using the LayerNorm approximation, making them computationally as cheap as the regular MaskNet models to evaluate.

The trained models are evaluated on the original test set and a corrupted version of the test set. We simulate out of-distribution data by applying corruption in the form of Gaussian noise on the numerical features. Shift intensities [6.25%, 12.5%, 25%, 50%] are based on units of the standard deviation of the original feature values. Finally, the difference in model performance was measured between the original models with LayerNorm and the adjusted models with MC-LayerNorm.

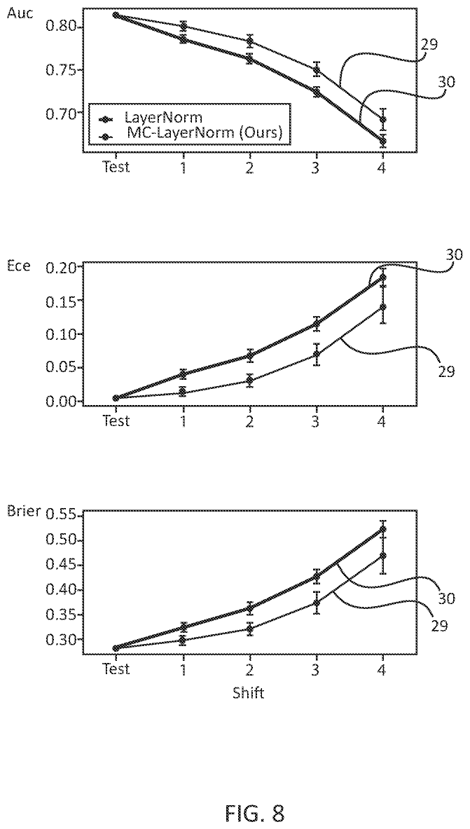

FIG. 8 depicts a plot of results on the Criteo dataset demonstrating an of MC-LayerNorm when it comes to all three of the considered metrics. As the tests set shift further out-of-distribution, the MC-LayerNorm method retains more of the original calibration and model performance compared to the baseline of the traditional LayerNorm. In the plot depicted in FIG. 8, the plot identified by reference number 30 is data having layers normalized with LayerNorm. In the plot depicted in FIG. 8, the plot identified by reference number 29 is data having layers normalized by Monte Carlo Layer Normalization.

Referring to FIG. 8, the Area under the Curve (AUC), Brier score and expected calibration error (ECE) for four shift intensities are all illustrated to compare the performance of the vanilla LayerNorm with MC-LayerNorm as increasing amounts of noise is applied to the test set. The experiment demonstrates a clear advantage of methods employing MC-LayerNorm, retaining more of the original model performance compared to the classical LayerNorm as the data shifts further out-of-distribution (plots show average over 10 runs; error bars indicate standard errors around the mean).

A novel normalization layer, i.e., MC-LayerNorm, has been described herein that can improve model calibration for in- and out-of distribution (OOD) data by injecting stochasticity through subsampling features when computing the normalization statistics. Compared to prediction-time BatchNorm, the MC-LayerNorm has the advantage of not requiring to be re-tuned on OOD samples, since it does not rely on batch-level statistics as it calculates statistics per channel instead of per batch. Consequently, methods employing MC-LayerNorm layers display calibration abilities that are independent of batch size, working for small but also for mixed in- and out-of-distribution batches. It can even work for inference on a single sample at a time.

MC-LayerNorm is able to perform zero-shot prediction-time domain adaptation, which gives it an advantage in real-world OOD use cases where a deployed model is being exposed for the first time to new OOD samples and has not had time to properly adapt to the covariate shift.

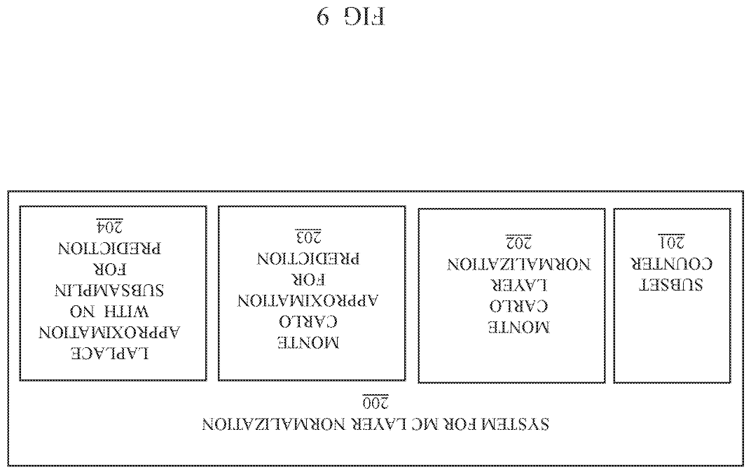

FIG. 9 is a block diagram of a system 200 for machine learning that employs a Monte Carlo (MC) layer normalization for calibrated uncertainty in deep learning methods. FIG. 9 illustrates one embodiment of a system for layer normalization in machine learning applications including a hardware processor; and a memory that stores a computer program product. The computer program product of the system includes instructions comprising sample, with the hardware processor, a random set of activations corresponding to fix fraction of the overall activations to provide a plurality of subsampled activations; compute, with the hardware processor, the average across the plurality of subsampled activations; and compute, using the hardware process, the standard deviation across the plurality of subsampled activations. The system can also employ, using the hardware processor, two statistics including the average of the subsampled activations and the standard deviation across the plurality of subsampled activations to normalize all of the activations as a layer normalization.

Referring to FIG. 9, the subset counter 201 collects a random set of activations, as described with respect to block 1 of the methods described above with reference to FIGS. 1 and 9. The Monte Carlo Layer Normalization 202 provides training steps as described above with reference to blocks 1-4 of FIGS. 1 and 2.

Still referring to FIG. 9, the system 200 also includes a Monte Carlo Approximation for Prediction engine 203. Further details for the Monte Carlo Approximation for Prediction engine 203 is found in the description of blocks 6 and 7 of FIG. 1. In the Monte Carlo approximation mode, the subsample input features provide for calculation of normalization statistics. In the Monte Carol approximation mode, a Bayesian perspective is employed. For the Bayesian perspective, N Monte Carlo iterations are run, and the average is employed for predictions.

Referring to FIG. 9, the system 200 can also include a Laplace approximation with no subsampling for prediction engine 204. This prediction engine can provide a one-shot approximation mode. The sampling procedure translates to MC-Integration and connects to bayesian model averaging.

With Laplace approximation a one-shot approximation mode can be provided with no subsampling of input features. Further details on the one shot approximately using the Laplace approximation with no subsampling for prediction engine 204 can be found above in the description of blocks 7 and 8 of FIG. 2.

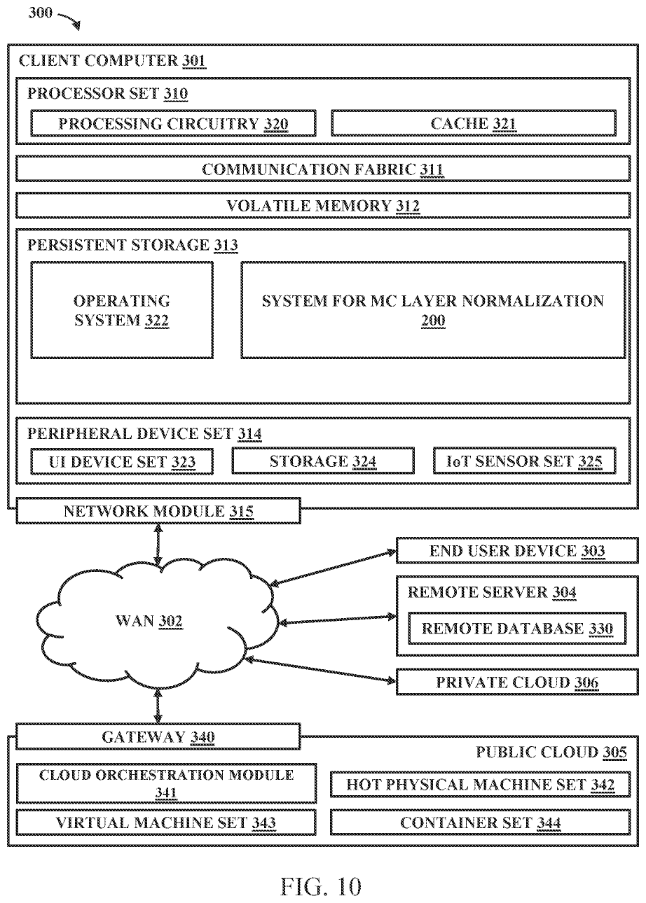

Referring to FIG. 10, in some embodiments, the components of the system 200 for MC layer Normalization for calibrated uncertainty in deep learning are in communication with at least one hardware processor (processor set 310), in which the hardware processor may function with the other elements depicted in FIG. 9 to provide the functions described above. FIG. 10 further illustrates a processing system 300 that can include the system 200 for MC layer Normalization that is described with reference to FIGS. 1-9.

Referring to FIG. 10, the computing environment 300 contains an example of an environment for the execution of at least some of the computer code involved in performing the inventive methods, such as the method for MC layer Normalization for calibrated uncertainty in deep learning 200. In addition to block 200, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 200, as identified above), peripheral device set 214 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible.

Computer 301 may be located in a cloud, even though it is not shown in a cloud in FIG. 10. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 200 in persistent storage 313.

COMMUNICATION FABRIC 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 314 includes the set of peripheral devices of computer 301. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315. WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments,

EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The present invention may be a system, a method, and/or a computer program product at any possible technical detail level of integration. For example, in some embodiments, a computer program product is provided for layer normalization in machine learning applications. The computer program product can include a computer readable storage medium having computer readable program code embodied therewith. The program instructions executable by a processor to cause the processor to sample, using the hardware processor, a random set of activations corresponding to fix fraction of the overall activations to provide a plurality of subsampled activations. The computer instructions also can compute, with the hardware processor, the average across the plurality of subsampled activations; and compute the standard deviation across the plurality of subsampled activations. Further, the computer program product can employ two statistics including the average of the subsampled activations and the standard deviation across the plurality of subsampled activations to normalize all of the activations as a layer normalization.

The computer program product may include a computer readable storage medium (or media) having computer readable program instructions thereon for causing a processor to carry out aspects of the present invention. The computer program product may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAS, and/or PLAs.

These and other variations of a hardware processor subsystem are also contemplated in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for Monte Carlo Normalization for calibrated uncertainty in deep learning (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer implemented method is for layer normalization in machine learning applications comprising:
sampling a random set of activations corresponding to fixed fraction of overall activations to provide a plurality of subsampled activations;
computing an average across the plurality of subsampled activations;
computing a standard deviation across the plurality of subsampled activations; and
employing two statistics including the average of the subsampled activations and the standard deviation across the plurality of subsampled activations to normalize all of the activations as a layer normalization.

2. The computer implemented method of claim 1, wherein the sampling of the random set of activations comprises selecting a set of neurons of a neural network having preactivations from a total number of neurons in the neural network.

3. The computer implemented method of claim 1, wherein the computing the average and the standard deviation from the plurality of subsampled activations to normalize all of the activations as the layer normalization comprises:
$${\tilde{μ}}^{l} = \frac{1}{\vert {S}_{l} \vert} {\sum }_{i ∈ {S}_{l}} {a}_{i}^{l} , {( {\tilde{σ}}^{l} )}^{2} = \frac{1}{\vert {S}_{l} \vert} {\sum }_{i ∈ {S}_{l}} {( {a}_{i}^{l} - {\tilde{μ}}^{l} )}^{2} , {\tilde{a}}_{i}^{l} = \frac{( {a}_{i}^{l} - {\tilde{μ}}^{l} )}{{\tilde{σ}}^{l}}$$
wherein the subsampled activations is equal to: S₁⊂[Nₗ]={1, . . . , Nₗ}
the average from the plurality of subsampled activations is equal to \tilde{μ}^{l}′,
the standard deviation from the plurality of subsampled activations is equal to \tilde{σ}^{l}, and the layer normalization is
$${\tilde{a}}_{i}^{l} = \frac{( {a}_{i}^{l} - {\tilde{μ}}^{l} )}{{\tilde{σ}}^{l}} ,$$
in which α is activations in a layer of a neural network.

4. The computer implemented method of claim 1, wherein the layer normalization is a step of a training sequence for a neural network used in machine learning of a model that controls a vehicle in an autonomous vehicle application.

5. The computer implemented method of claim 1, wherein the layer normalization is a step of a training sequence for a neural network used in machine learning of a model in an object identification application.

6. A computer implemented method for layer normalization in machine learning applications comprising:
performing a training sequence that includes sampling a random set of activations corresponding to fix fraction of overall activations to provide a plurality of subsampled activations, computing an average across the plurality of subsampled activations, computing a standard deviation across the plurality of subsampled activations, and employing two statistics including the average of the subsampled activations and the standard deviation across the plurality of subsampled activations to normalize all of the activations as a layer normalization; and
performing an evaluation sequence employing a Monte Carlo approximation that includes using a subsample input feature for calculation of normalization statics, and computing the average of running a network forward multiple times with the layer normalization from the training sequence, wherein the average is an output providing a prediction.

7. The computer implemented method of claim 6, wherein the sampling a random set of activations comprises selecting a set of neurons of a neural network having preactivations from a total number of neurons in the neural network.

8. The computer implemented method of claim 6, wherein computing the average and the standard deviation from the plurality of subsampled activations to normalize all of the activations as the layer normalization comprises:
$${\tilde{μ}}^{l} = \frac{1}{\vert {S}_{l} \vert} {\sum }_{i ∈ {S}_{l}} {a}_{i}^{l} , {( {\tilde{σ}}^{l} )}^{2} = \frac{1}{\vert {S}_{l} \vert} {\sum }_{i ∈ {S}_{l}} {( {a}_{i}^{l} - {\tilde{μ}}^{l} )}^{2} , {\tilde{a}}_{i}^{l} = \frac{( {a}_{i}^{l} - {\tilde{μ}}^{l} )}{{\tilde{σ}}^{l}}$$
wherein the subsampled activations is equal to: Sₗ⊂[Nₗ]={1, . . . , Nₗ},
the average from the plurality of subsampled activations is equal to \tilde{μ}^{l},
the standard deviation from the plurality of subsampled activations is equal to \tilde{σ}^{l}, and
the layer normalization is
$${\tilde{a}}_{i}^{l} = \frac{( {a}_{i}^{l} - {\tilde{μ}}^{l} )}{{\tilde{σ}}^{l}} ,$$
in which a^{˜1}.

9. A computer implemented method is provided for layer normalization in machine learning applications comprising:
performing a training sequence that includes sampling a random set of activations corresponding to fix fraction of overall activations to provide a plurality of subsampled activations, computing an average across the plurality of subsampled activations, computing a standard deviation across the plurality of subsampled activations, and employing two statistics including the average of the subsampled activations and the standard deviation across the plurality of subsampled activations to normalize all of the activations as a layer normalization; and
performing an evaluation sequence employing a sampling procedure that translates to a Monte Carlo layer normalization of the training sequence, and employing a Laplace approximation to provide a prediction without subsampling of input features.

10. The computer implemented method of claim 9, wherein the sampling of the random set of the activations comprises selecting a set of neurons of a neural network having preactivations from a total number of neurons in the neural network.

11. The computer implemented method of claim 9, wherein the computing the average and the standard deviation from the plurality of subsampled activations to normalize all of the activations as the layer normalization comprises:
$${\tilde{μ}}^{l} = \frac{1}{\vert {S}_{l} \vert} {\sum }_{i ∈ {S}_{l}} {a}_{i}^{l} , {( {\tilde{σ}}^{l} )}^{2} = \frac{1}{\vert {S}_{l} \vert} {\sum }_{i ∈ {S}_{l}} {( {a}_{i}^{l} - {\tilde{μ}}^{l} )}^{2} , {\tilde{a}}_{i}^{l} = \frac{( {a}_{i}^{l} - {\tilde{μ}}^{l} )}{{\tilde{σ}}^{l}}$$
wherein the subsampled activations is equal to: S₁⊂[Nₗ]={1, . . . , Nₗ},
the average from the plurality of subsampled activations is equal to \tilde{μ}^{l},
the standard deviation from the plurality of subsampled activations is equal to \tilde{σ}^{l}, and
the layer normalization is
$${\tilde{a}}_{i}^{l} = \frac{( {a}_{i}^{l} - {\tilde{μ}}^{l} )}{{\tilde{σ}}^{l}} ,$$
in which a^{˜1}.

12. The computer implemented method of claim 9, wherein the Laplace approximation is equal to:
$$\frac{1}{N} {{\sum }^{N}}_{n = 1} {p}_{{\hat{θ}}_{n}} ( y \vert x ) with {\hat{θ}}_{n} ∼ {q}_{0} ( \hat{θ} ) = \frac{1}{N} {{\sum }^{N}}_{n = 1} softmax ( {f}_{{\hat{θ}}_{n}} ( x ) ) \approx softmax ( \overline{{f}_{θ}} ( x ) ) .$$

13. A system for layer normalization in machine learning applications including a hardware processor; and a memory that stores a computer program product, the computer program product of the system includes instructions comprising:
sample, with the hardware processor, a random set of activations corresponding to fix fraction of overall activations to provide a plurality of subsampled activations;
compute, with the hardware processor, an average across the plurality of subsampled activations;
compute, using the hardware processor, a standard deviation across the plurality of subsampled activations; and
employ, using the hardware processor, two statistics including the average of the subsampled activations and the standard deviation across the plurality of subsampled activations to normalize all of the activations as a layer normalization.

14. The system of claim 13 further comprising to perform with the hardware processor an evaluation sequence employing a Monte Carlo approximation that includes using a subsample input feature for calculation of normalization statics, and computing the average of running a network forward multiple times with the layer normalization, wherein the average is an output providing a prediction.

15. The system of claim 13 further comprising to perform, with the hardware processor, an evaluation sequence employing a sampling procedure that translates to a Monte Carlo layer normalization, and employing a Laplace approximation to provide a prediction without subsampling of input features.

16. The system of claim 13, wherein the sampling of the random set of activations comprises selecting a set of neurons of a neural network having preactivations from a total number of neurons in the neural network.

17. The system of claim 13, wherein the computing the average and the standard deviation from the plurality of subsampled activations to normalize all of the activations as the layer normalization comprises:
$${\tilde{μ}}^{l} = \frac{1}{\vert {S}_{l} \vert} {\sum }_{i ∈ {S}_{l}} {a}_{i}^{l} , {( {\tilde{σ}}^{l} )}^{2} = \frac{1}{\vert {S}_{l} \vert} {\sum }_{i ∈ {S}_{l}} {( {a}_{i}^{l} - {\tilde{μ}}^{l} )}^{2} , {\tilde{a}}_{i}^{l} = \frac{( {a}_{i}^{l} - {\tilde{μ}}^{l} )}{{\tilde{σ}}^{l}}$$
wherein the subsampled activations is equal to: Sₗ⊂[Nₗ]={1, . . . , Nₗ},
the average from the plurality of subsampled activations is equal to \tilde{μ}^{l},
the standard deviation from the plurality of subsampled activations is equal to \tilde{σ}^{l}, and
the layer normalization is
$${\tilde{a}}_{i}^{l} = \frac{( {a}_{i}^{l} - {\tilde{μ}}^{l} )}{{\tilde{σ}}^{l}} ,$$
in which a^{˜1}.

18. The system of claim 13, wherein the layer normalization is a step of a training sequence for a neural network used in machine learning of a model that controls a vehicle in an autonomous vehicle application.

19. The system of claim 13, wherein the layer normalization is a step of a training sequence for a neural network used in machine learning of a model in an object identification application.

20. A computer program product for layer normalization in machine learning applications, the computer program product including a computer readable storage medium having computer readable program code embodied therewith, the program code executable by a hardware processor to cause the hardware processor to:
sample a random set of activations corresponding to fix fraction of an overall activations to provide a plurality of subsampled activations;
compute an average across the plurality of subsampled activations;
compute a standard deviation across the plurality of subsampled activations; and
employ two statistics including the average of the subsampled activations and the standard deviation across the plurality of subsampled activations to normalize all of the activations as a layer normalization.

21. The computer program product of claim 20 further comprising to perform with the hardware processor an evaluation sequence employing a Monte Carlo approximation that includes using a subsample input feature for calculation of normalization statics, and computing the average of running a network forward multiple times with the layer normalization, wherein the average is an output providing a prediction.

22. The computer program product of claim 20 further comprising to perform, with the hardware processor, an evaluation sequence employing a sampling procedure that translates to a Monte Carlo layer normalization, and employing a Laplace approximation to provide a prediction without subsampling of input features.

23. The computer program product of claim 20, wherein the computing the average and the standard deviation from the plurality of subsampled activations to normalize all of the activations as the layer normalization comprises:
$${\tilde{μ}}^{l} = \frac{1}{\vert {S}_{l} \vert} {\sum }_{i ∈ {S}_{l}} {a}_{i}^{l} , {( {\tilde{σ}}^{l} )}^{2} = \frac{1}{\vert {S}_{l} \vert} {\sum }_{i ∈ {S}_{l}} {( {a}_{i}^{l} - {\tilde{μ}}^{l} )}^{2} , {\tilde{a}}_{i}^{l} = \frac{( {a}_{i}^{l} - {\tilde{μ}}^{l} )}{{\tilde{σ}}^{l}}$$
wherein the subsampled activations is equal to: Sₗ=[Nₗ]={1, . . . , Nₗ},
the average from the plurality of subsampled activations is equal to \tilde{μ}^{l},
the standard deviation from the plurality of subsampled activations is equal to \tilde{σ}^{l}, and
the layer normalization is
$${\tilde{a}}_{i}^{l} = \frac{( {a}_{i}^{l} - {\tilde{μ}}^{l} )}{{\tilde{σ}}^{l}} ,$$
in which a^{˜1}.

24. The computer program product of claim 20, wherein the layer normalization is a step of a training sequence for a neural network used in machine learning of a model that controls a vehicle in an autonomous vehicle application.

25. The computer program product of claim 20, wherein the layer normalization is a step of a training sequence for a neural network used in machine learning of a model in an object identification application.
